(19) United States
(12) Patent Application Publication
(10) Pub. No.: US 2007/0224363 A1
(43) Pub. Date: Sep. 27, 2007

(54) PROCESS AND DEVICE FOR PREDICTING COATING THICKNESS

(75) Inventors: Oliver Kurz, Aichwald (DE); Gunnar Possart, Kaiserslautern (DE); Matthias Schmidt, Stuttgart (DE); Paul Steinmann, Kaiserslautern (DE)

Correspondence Address: AKERMAN SENTERFITT, P.O. BOX 3188, WEST PALM BEACH, FL, 33402-3188, US

(73) Assignee: DaimlerChrysler AG, Stuttgart (DE)

(21) Appl. No.: 11/689,261

(22) Filed: Mar. 21, 2007

(30) Foreign Application Priority Data
Mar. 21, 2006 (DE) 10 2006 012 849.4
Jul. 21, 2006 (DE) 10 2006 033 721.2

(51) Int. Cl. B05D 1/18; B05D 1/04; B05C 3/00

(52) U.S. Cl. 427/430.1; 427/458; 118/400

(57) ABSTRACT

A process and a device for prediction of the thickness of a layer of a coating or paint applied upon an object by dip painting. The paint layer thickness (h) at at least one point on the surface of the object (2) is predicted. A correlation between the paint layer thickness and the current density in the paint layer (3) is empirically determined. Further, a correlation between the specific resistance of the paint layer (3) and the current density in the paint layer (3) is empirically determined. Depending upon the value of the applied voltage, the electrical potential at the point is calculated. The current density, the paint layer thickness and the specific resistance of the paint layer (3) at the point following dip coating are calculated. For this the electrical potential at the point as well as two correlations are employed.

### BACKGROUND OF THE INVENTION

1. Field of Invention

The invention concerns a process and a device for predicting the thickness of a coated (painted) layer, which is applied onto an object by dip coating (dip painting).

2. Related Art of the Invention

U.S. Pat. No. 6,790,331 B2 discloses a process and a device of the generic type. In order to calculate layer thickness, the following variables are utilized in U.S. Pat. No. 6,790,331 B2:
the density p of the coating (“film density”),
an “electrodeposition coating equivalent” K_f,
a current density (“film deposition current density”) I_c,
a “current efficiency” C.E.
a finite element model of the to-be-coated object, of the dip basin, and of the counter-electrode (here: the anode).

An electrical potential Φ and, from this, a current density i were calculated.

In DE 10 2004 003 456 A1 a process and a system for deternining the thickness of a coating layer are described. The electrical charge flowing through the object to be coated is measured. Also measured is the area of the surface of the object to be subjected to the coating process. The surface is determined for example on the basis of the maximum startup current flowing through the object at the start of the dip coating process.

In US 2002/0139678 A1 a process is described for controlling a process, in which work pieces are galvanically coated (“electroplating”). A Jacobi-sensitivity-matrix describes the influence of the set value of the voltage on the layer thickness produced.

In U.S. Pat. No. 6,542,784 B1 the process is described for analytically modeling the current density and the electrical potential distribution during a galvanic coating. A three dimensional Lagrange equation and a Poisson equation are established and evaluated.

The invention is concerned with a task, of providing a process and a device with which the thickness of the coated layer, which is applied during dip coating, can be more realistically predicted.

### SUMMARY OF THE INVENTION

The invention is solved by a process in which the coating thickness is predicted at at least one point on the surface of the object. Empirically a correlation between the coated layer thickness and the current density of the coated layer is determined. In addition, empirically a correlation is determined between the specific resistance of the coating layer and the current density in the coated layer. Depending upon the magnitude of the applied voltage, the electrical potential at the point is calculated. The current density, the coated layer thickness and the specific resistance of the coated layer at the point after dip coating are calculated. For this, the electrical potential in the point as well as both correlations are employed.

The inventive process envisions taking into consideration, in the prediction of the coated layer thickness, both the current density as well as the specific resistance of the coated layer. The dependency of these two variables from the current density are empirically determined. Since these dependences are determined empirically, no analytical model is needed as to how the coated layer or the specific resistance depends upon the current density. The term “analytical model” as used herein means that the dependency is described on the basis of theoretical considerations. To set up and validate such an analytical model is often very difficult or even impossible.

### BRIEF DESCRIPTION OF THlE DRAWINGS

In the following an illustrative example of the invention is described in greater detail on the basis of the associated figures. There is shown in:

FIG. 1 a dip basin with cathodic electrolytic coating;

FIG. 2 schematic representation of the layer build-up of the coating on a work piece;

FIG. 3 the volatage between anode and cathode, changing over time;

FIG. 4 the influence of the wrap-around of the coating;

FIG. 5 the top view on the dip basin in which coating parameters are measured;

FIG. 6 the circuit diagram for the measurement of the dip basin of FIG. 5;

FIG. 7 the time sequence of the current amplitude;

FIG. 8 the time sequence of the current density;

FIG. 9 the time sequence of the layer thickness;

FIG. 10 the correlation between layer thickness growth and current density;

FIG. 11 the correlation between specific resistance and the thickness of the coated layer;

FIG. 12 the correlation between the change over time of the specific resistance and the current density;

FIG. 13 the correlation between the change over time of the layer resistance and the current density;

FIG. 14 a construction model for an anode (left) as well as an integration of this construction model with surface elements (right);

FIG. 15 construction model for one-half of the dip basin (left) as well as an integration of this construction model with surface elements (right);

FIG. 16 the construction model of one half of the dip basin, the holder and the anode;

FIG. 17 an integration of the inside of the dip basin from FIG. 16 with volume elements;

FIG. 18 a flow diagram showing the computation of the coating thickness;

FIG. 19 the computation steps of S3 of FIG. 18.

### DETAILED DESCRIPTION OF THE INVENTION

The illustrative embodiment demonstrates coating by electrolytic deposition wherein the work piece is coated in a dip basin. This work piece thus functions as the object to be coated. It exhibits an electrically conductive surface. Examples of electrically conductive surfaces include surfaces of steel, aluminum, copper or other metals as well as surfaces of metallic coated plastic.

As a result of coating, at least one organic layer it is applied upon the electrically conductive surface. This at least one organic layer reduces the ion-transport and the electrical conductivity in those respective areas of the work piece, which come into contact with water. Thereby the applied organic layer reduces corrosion in these areas or at least retards corrosion.

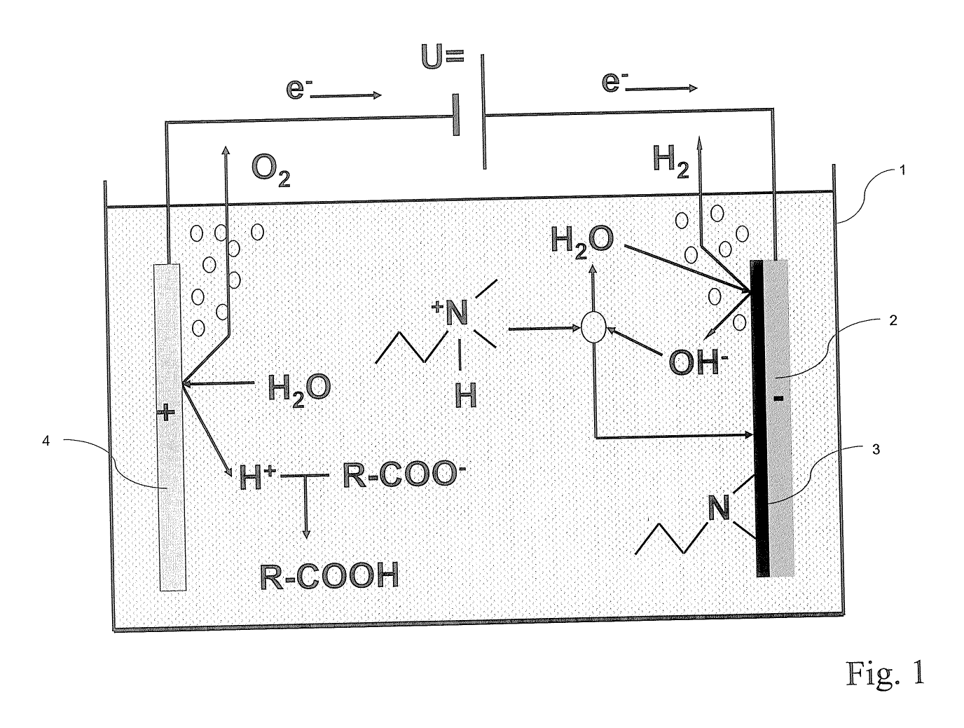

FIG. 1 illustrates by way of example which electrochemical processes occur during electrolytic coating. There is shown a dip basin 1 in which a work piece 2 with an electrically conductive surface is immersed. In the dip basin 1 there is a coating liquid, which preferably includes polymers as well as solvents. Metallic particles such as zinc particles can be dissolved or dispersed in the coating liquid. By coating, a coating layer 3 is produced on this electrically conductive surface. In FIG. 1 a cathodic dip coating is shown. The work piece 2 functions as the cathode in the dip basin 1. An anode 4 is also provided in the dip basin 1. The cathode, anode 4 a voltage source, and the coating liquid in the dip basin 1 together form a closed circuit. The anode 4 is insulated relative to the cathode in such a manner that no short circuit occurs. The coating material deposits upon the cathode and therewith upon the immersed work piece 2.

The process can be used for the cathodic dip coating as shown in FIG. 1 and in similar mamier for an anodic dip coating. In an anodic dip coating the work piece 2 functions as the anode of the closed circuit in the dip basin 1. The coating deposits on the anode. Cathodic dip coating exhibits the advantage, in comparison to anodic, that no electrolytic solution of the metal occurs as in the case of the anodic dip coating.

In the cathodic dip coating the electrical current causes, as shown in FIG. 1, splitting of the water at the cathode to an OH⁻ ion and a H⁺ ion. The OH⁻ bonds to a component of the coating to form an electrically slightly conductive layer on the work piece 2. The speed of the process of the cleaving of the water depends on the strength of the applied current.

The degree to which the coating layer 3 impedes the corrosion of the work piece 2 depends upon
the electrical, chemical and mechanical characteristics of the coating,
the force of adhesion of the coating on the electrically conductive surface,
the permeability of the applied layer to ions and water,
the thickness of the applied layer.

A thickness of the applied coating layer that is too thin reduces the corrosion protection of the work piece. A coating layer that is too thick has the following disadvantages:
Mechanical stress of the coated work piece can lead to separation or peeling of the coating.
Too much coating liquid is consumed, which is expensive and time consuming and unnecessarily pollutes the environment.

The thickness of the applied coating layer depends upon various parameters during the coating process. These parameters include
the electrical voltage applied to the anode relative to the cathode in the dip basin 1,
the temperature of the liquid in the dip basin 1,
the conductivity of the liquid in the dip basin 1.

The conductivity of the liquid depends upon its chemical composition and its temperature.

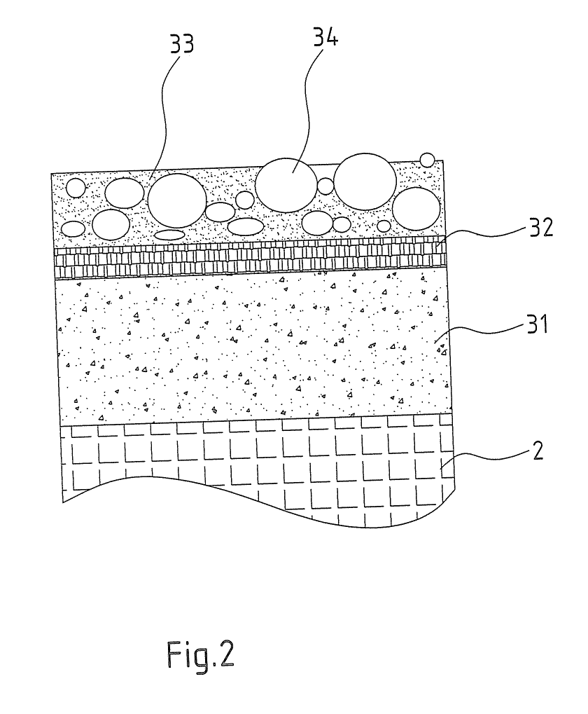

In FIG. 2 an example of the schematic buildup of the coating of a work piece 2 is shown. The work piece is steel sheet metal. On this steel sheet metal there are applied successively:
an electrically conductive coating 31, for example in metallic paint,
a phosphatization layer 32,
an organic layer 33 with zinc particles 34.

By the application of the electrically conductive paint and the phosphatizing the work piece of steel sheet metal is pre-treated.

A special layer buildup on the pre-treated work piece 2 or a high roughness of the surface of the work piece 2 can lead to local voltage peaks during the coating process. This could influence the deposit behavior. In particular, in an organic pre-treatment which is comprised of an only minimally conductive part and protruding metal particles, a changed current flow occurs. The zinc particles in the organic layer of FIG. 2 are an example of such an organic coating which leads to voltage peaks.

The inventive process automatically predicts the thickness of the applied coating layer 3. This layer thickness can be varied locally. The process takes into consideration the specific design or shape of the work piece 2.

In preliminary tests the empirical parameters of the applied coating are determined. For these preliminary tests, an understanding of the geometry of the work piece 2 is not needed. Rather, a test work piece 102 is employed. This is dipped in the test in a test dip basis 101, and the obtained coating is measured. Further, a knowledge of the subsequently-to-be employed dip basin 1 is not necessary. Rather, a test dip basin 101 is employed.

In the illustrative embodiment various tests were carried out, wherein each time a test work piece 102 is subjected to an electrolytic coating in a test dip basin 101. Preferably first a first test work piece 102.1 is employed, which has the shape of a quadratic sheet. Subsequently a second test work piece 102.2 is employed, which is described in greater detail below.

Respectively at least one test with the first test work piece 102.1 and the second test work piece 102.2 is carried out for:
each composition of the coating liquid to be taken into consideration,
each material to be considered for the electrically conductive surface of the work piece 2, and
each pre-treatment to be considered for the electrically conductive surface.

In the example according to FIG. 2 respectively one test is carried out for each of the electrically conductive paints and each phosphatizing to be considered, which are to be applied upon this electrically conductive paint. Preferably, respectively one test is carried out for each method of pre-treatment to be considered for the method under consideration.

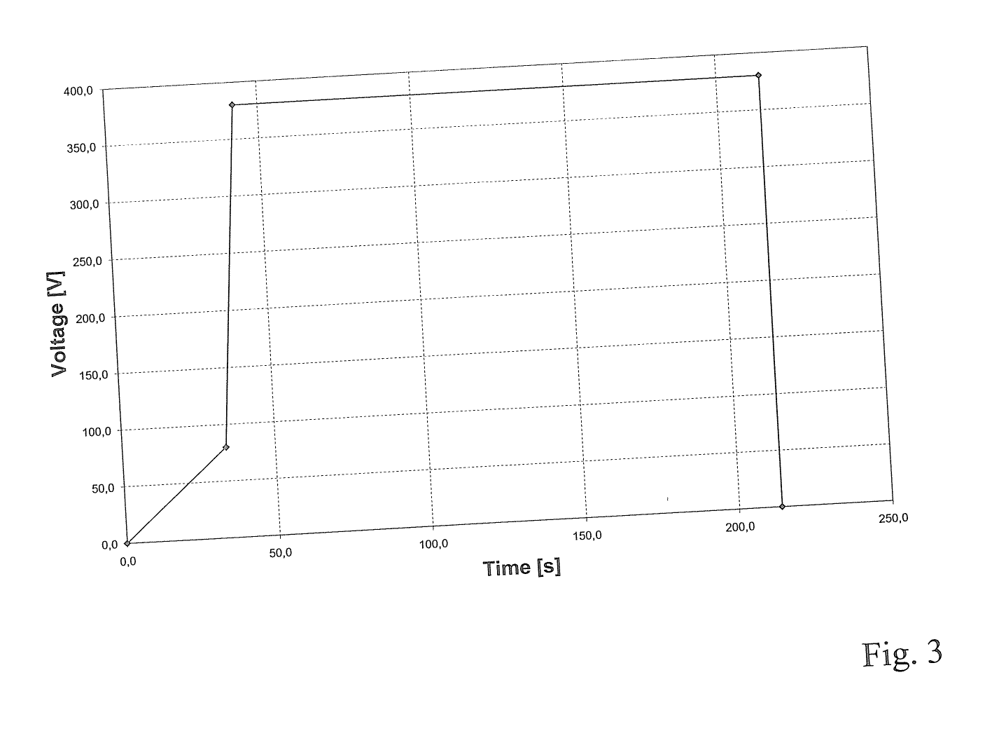

In the test, functional correlations between parameters of the painting process are determined empirically, which is described in greater detail below. For this, cathodic electrolytic painting is carried out in the test with different voltages between anode and cathode. By varying the current the non-linear dependency of the painting layer growth rate from the applied current is in particular taken into consideration. In one embodiment the applied current remains constant for a predetermined period of time of, for example, two seconds, and before and after this time is zero. In another embodiment the applied current varies with time. FIG. 3 shows the changing course of current between anode and cathode over time.

Further it is taken into consideration that the test basin 101 used in the test is significantly smaller than the dip basin 1 employed in production, and thus has a lower resistance. This is compensated by reducing the current.

The tests are preferably first carried out for the first test work piece 102.1, which for example has the shape of a quadratic sheet. The functional correlations produced empirically in these tests are subsequently verified with a second test work piece 102.2. During electrolytic painting of this second test work piece 102.2 a wrap-around of the painting occurs during painting.

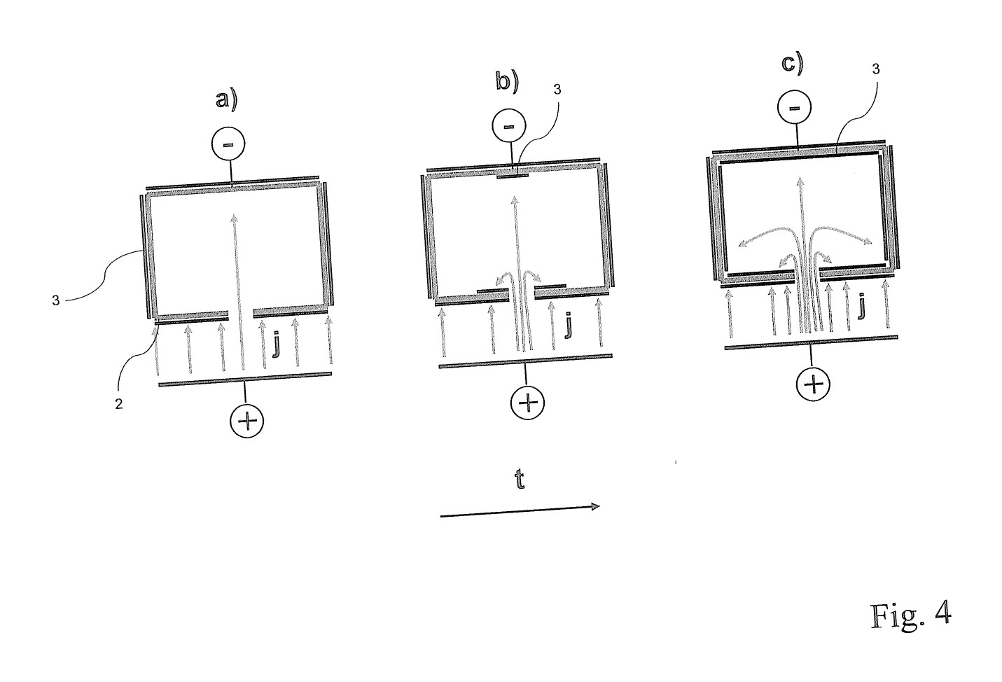

FIG. 4 gives an overview of the effect of the wrapping around of the painting. In this example, a sheet is shown is top view, which circumscribes a cylinder and exhibits a gap. From left towards right three instantaneous images are shown staggered over time. It can be seen how the wrap-around of the painting leads thereto that the sheet is also painted from the inside.

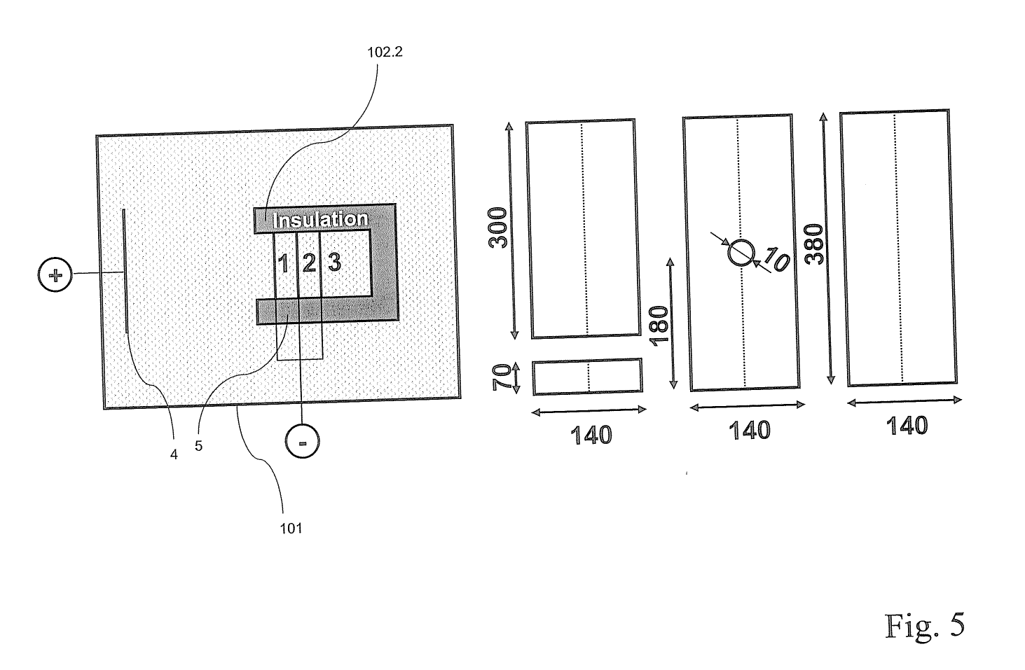

FIG. 5 shows a test construction with use of the second test work piece 102.2. In the embodiment, the second test work piece 102.2 is comprised of three different quadratic sheets, which respectively are 1 mm thick. The sheets respectively have a dimension of 300 mm×140 mm. The sheet I has a gap of 10 mm breadth over its entire width. The sheet II exhibits a hole of 10 mm diameter in the center. The sheet III has no recesses.

In FIG. 5 the test dip basin 101 used in the test is shown in top view. Shown in the figure is the holder 5 which is made of insulated plastic. The holder 5 forms a frame, which is interrupted only at the head and lid side. In this holder 5 up to three sheets can be attached in parallel, and namely with a separation of respectively 5 mm to 20 mm to each other. The test dip basin 101 is so designed so that a homogenous as possible field is produced between the anode 4 and the test work piece 102.2 functioning as cathode.

FIG. 5 shows on the right the three sheets of the test work piece 102.2 in top view, and namely from left to right the sheet I with gap, the sheet II with hole and the sheet III without recess or cut out.

In the test, in which all three sheets are hung parallel in the test dip basin 101, the wrap around characteristics of the painting are determined. Therein it is determined how quickly a paint layer 3 deposits on the areas of the test work piece 102 not directly visible from the anode 4.

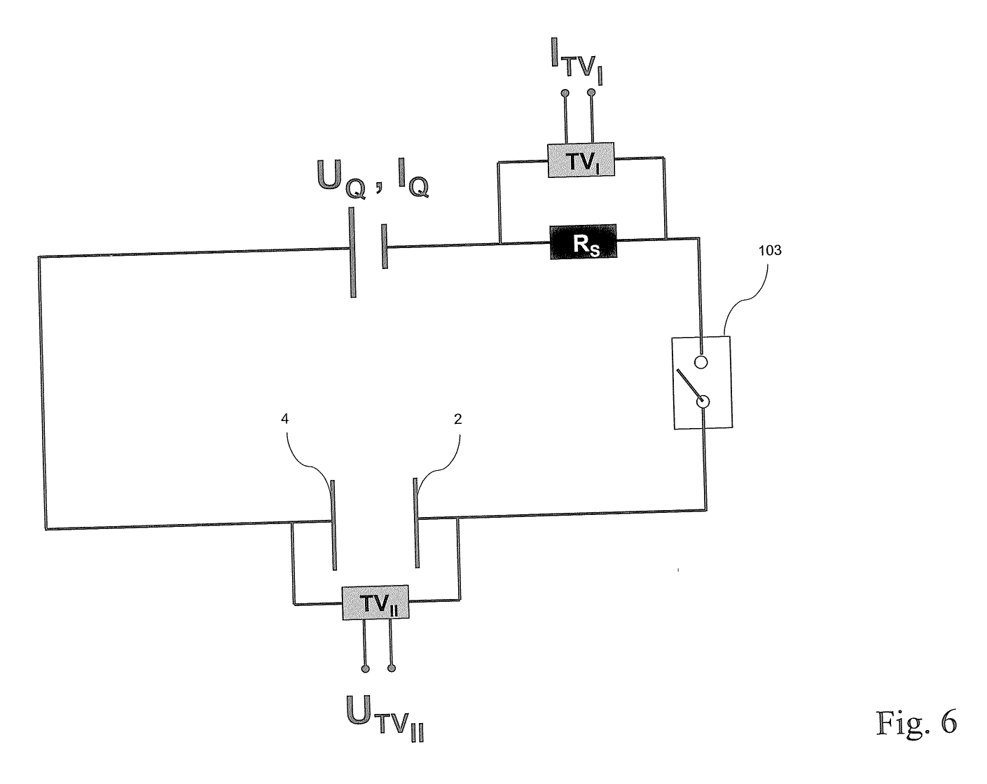

FIG. 6 shows a circuit diagram for taking readings in the test dip basin 101 of FIG. 5. The circuit diagram shows a switch 103. Measured values are the voltage U_TV_II between anode 4 and cathode 2 as well as the current strength I_TV_I in the circuit with the anode 4 and cathode 2.

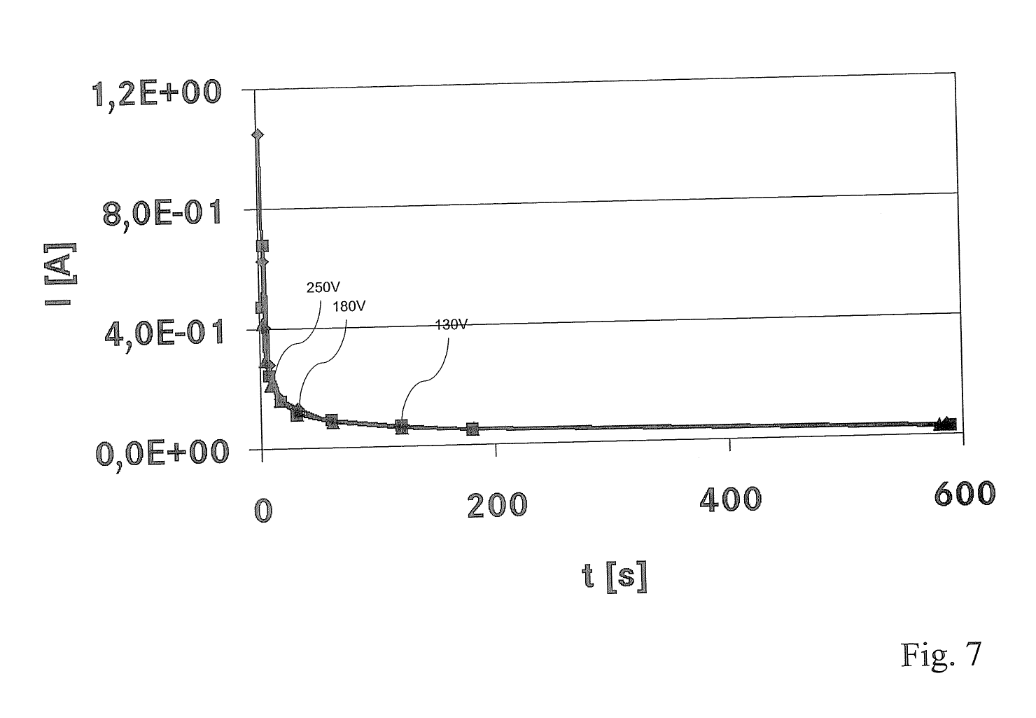

In the example according to FIG. 7, the test results are shown for three different voltages, namely 130 V (square), 180 V (triangle) and 250 V (diamond). Shown is the measured current strength I in [amperes] over time. The painted surface A of the test work piece 102 is a known.

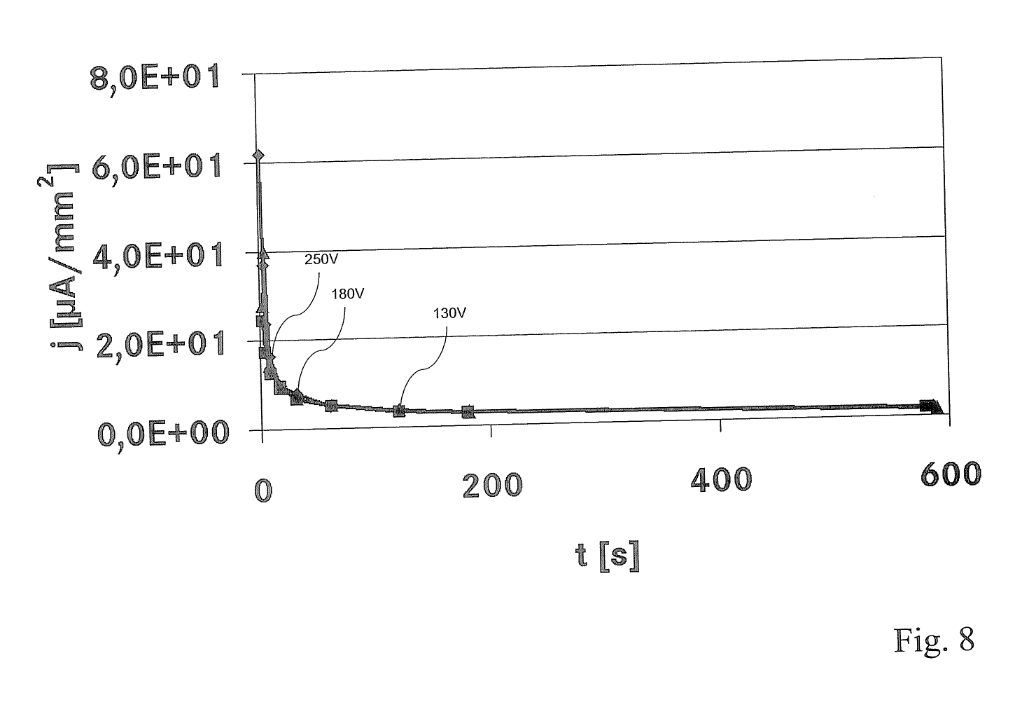

From the test results, which are shown in FIG. 7, the current density j over time is calculated. FIG. 8 shows the current density j in [micro-amperes per mm²] over time.

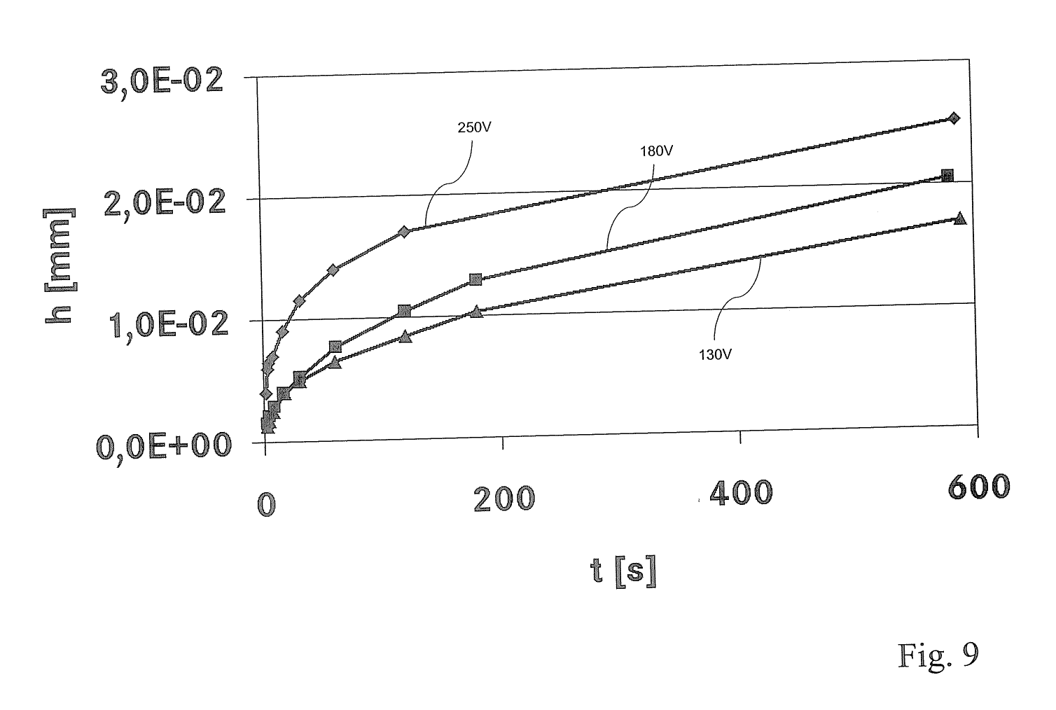

FIG. 9 shows the measured sequence over time of the layer thickness h [mm] as a function of the painting time t in [sec]. Herein the respective layer thickness h is measured for example at the nine painting time points t=2 sec, t=4 sec, t=8 sec, t=16 sec, t=32 sec, sec, t=128 sec, t=256 sec and t=512 of painting time. The respective nine measurements are carried out for each of the three voltages 130 V, 180 V and 250 V between anode and cathode.

Each measurement is carried out according to the following: the test work piece 102 is held in the test dip basin 101 for the respective painting time t. Subsequently the test work piece 102 is again removed from the test dip basin 101. The paint is fixed by baking. After baking the respective resulting layer thickness h is measured.

From the nine measurements for a particular voltage between anode and cathode numerically the growth

$$\frac{ⅆ h}{ⅆ t}$$

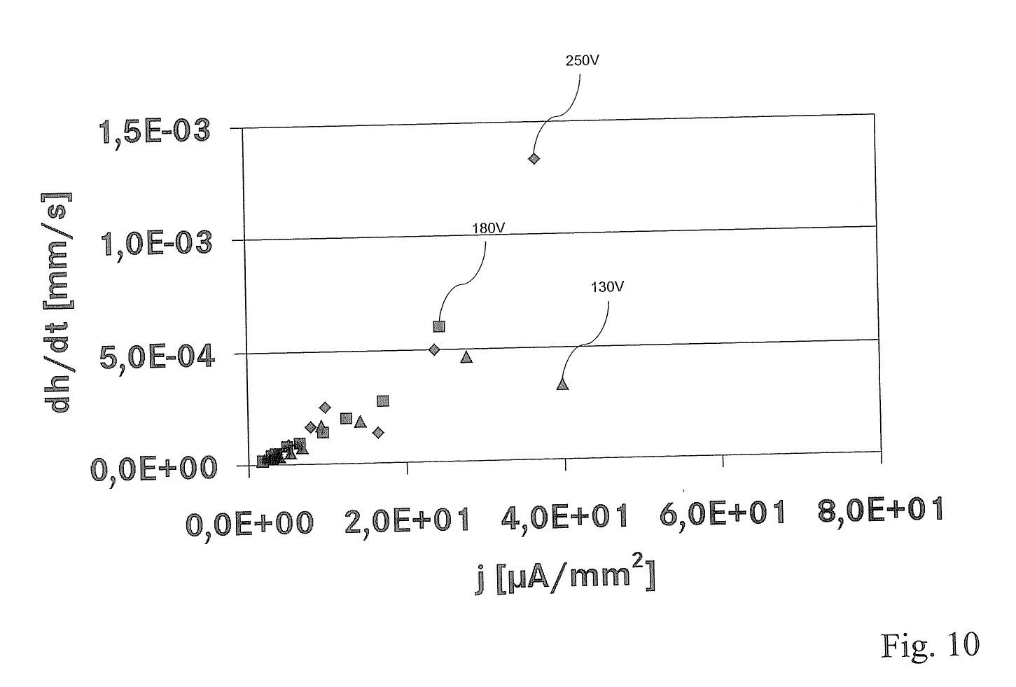

of the layer thickness, that is, the change in layer thickness over time, is determined. Per voltage nine values for the layer thickness growth are measured at nine different points in time. In FIG. 10 the correlation between layer thickness growth and current density is shown. Per voltage nine measurement points are shown in one diagram. On the small x-axis of the diagram the current density is shown in [μA/mm²] and on the y-axis the layer thickness growth in [mm/sec]. Measurement values for 130 V are shown with a triangle, measurement values for 180 V with a square and measurement values for 250 V with a diamond.

From the measurement values, which are shown for example in FIG. 10, empirically a correlation is determined between the layer growth, that is, the time derivative

$$\frac{ⅆ h}{ⅆ t} ,$$

and the current density j. One such correlation is valid for a layer viscosity, a material and a pre-treatment. Tests have shown, that this correlation is valid with sufficient precision for each voltage being considered. For example, a regression analysis is carried out. Here a functional correlation

$$\frac{ⅆ h}{ⅆ t} = AE * {( j - j 0 )}^{α}$$

for j>j0 is predicted. The parameters AE, j0 and α are calculated in a regression analysis, for example, such that they minimize the error square sum. The parameter AE is the paint deposit per electrical charge in the paint liquid and has, for example, the measurement unit “gram per Coulomb”. The parameter j0 describes the activation current thickness. Only when the current density is >j0 is paint deposited upon the pre-treated surface of the work piece 2. In the case that

$$j <= j 0 , \frac{ⅆ h}{ⅆ t} = 0.$$

From “Dubbel-Handbook for Mechanical Engineering,” 20^{th} Edition, Springer-Publishing House, 2001, V3, the concept of the specific resistance of p is known. For an elongated conductor in the fonrn of a wire with a length l and a cross section A, the following equation applies between resistance R and specific resistance p: R=p*l/A=l/(κ*A). Herein the κ is the conductivity of the conductor. There results: κ=l/p, the conductivity is the reciprocal value of the specific resistance p.

For a paint layer, which is applied upon a component with a surface area A, the resistance is described with the aid of the layer resistance P_Paint of the paint layer. It is P_Paint=R_Paint*A and R_Paint=P_Paint/A. The layer resistance P is indicated for example in [MΩ*mm²]. Between the layer resistance P_Paint, the specific resistance p_Paint and the thickness h of the paint layer the correlation applies P_Paint=p_Paint*h.

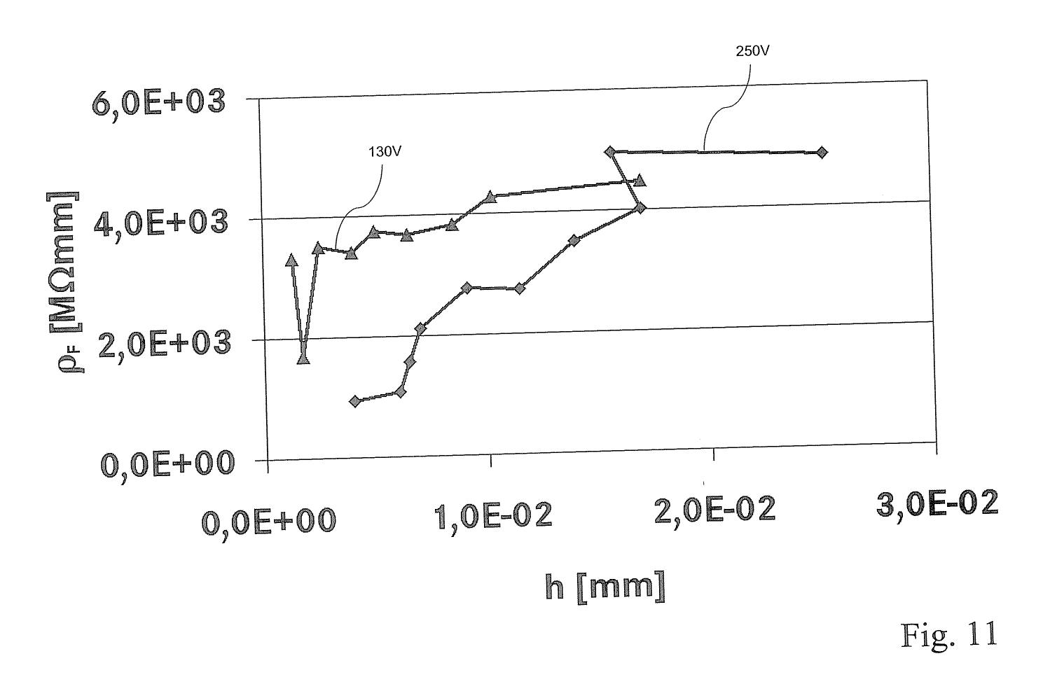

FIG. 11 shows the measured correlation between the specific resistance p_Paint and the layer thickness h of the paint. On the x-axis the layer thickness h is indicated in [mm], on the y-axis the specific resistance p_Paint in [MΩ*mm]. The curve 130 V shows the empirically determined correlation with 130 V, the curve 250 V that the for 250 V.

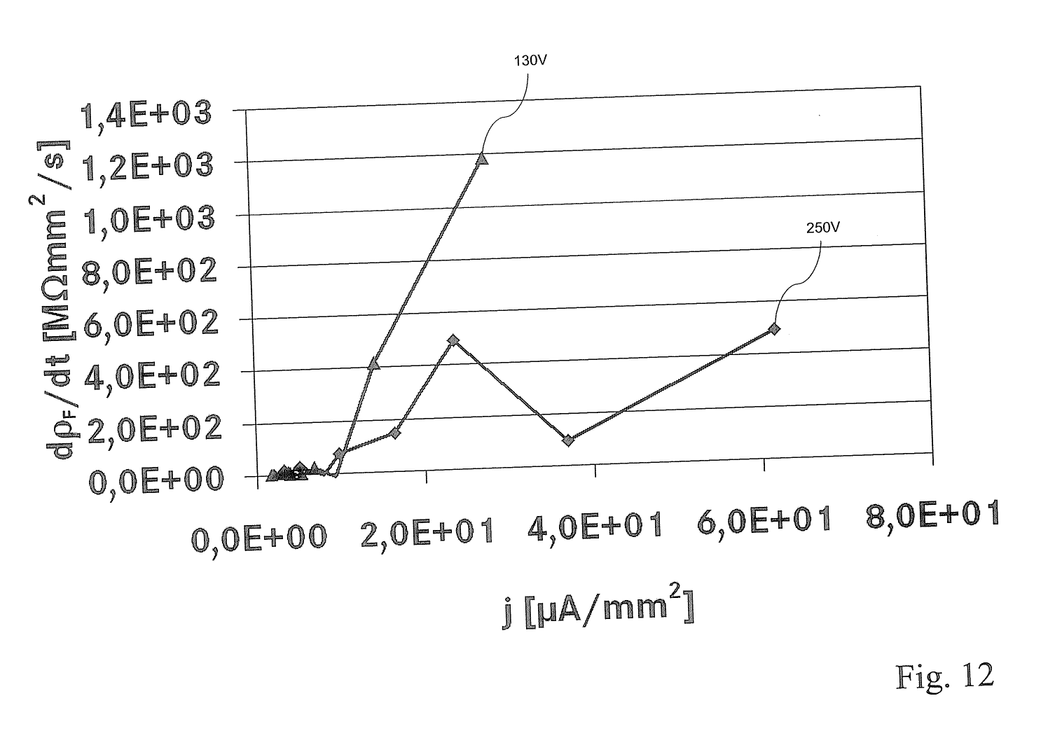

FIG. 12 shows the correlation between
the change over time of the specific resistance p_Paint, that is the time derivative dp_Paint/dt, the paint layer and
the current density j through the paint layer 3.

The functional correlation shown in FIG. 12 is not directly measured, rather is calculated from measurement values.

Also for the determination of this correlation preferably a regression analysis is carried out. For this a functional correlation dp_Paint/dt-dp0_Paint*[l−e^{β*(j-j0)}] is predetermined. The parameter dp0_Paint and β are calculated in the regression analysis. The parameter dp0_Paint describes the increase of the specific layer resistance in the saturation condition. In the case that j<=j0, then dp_Paint/dt=0.

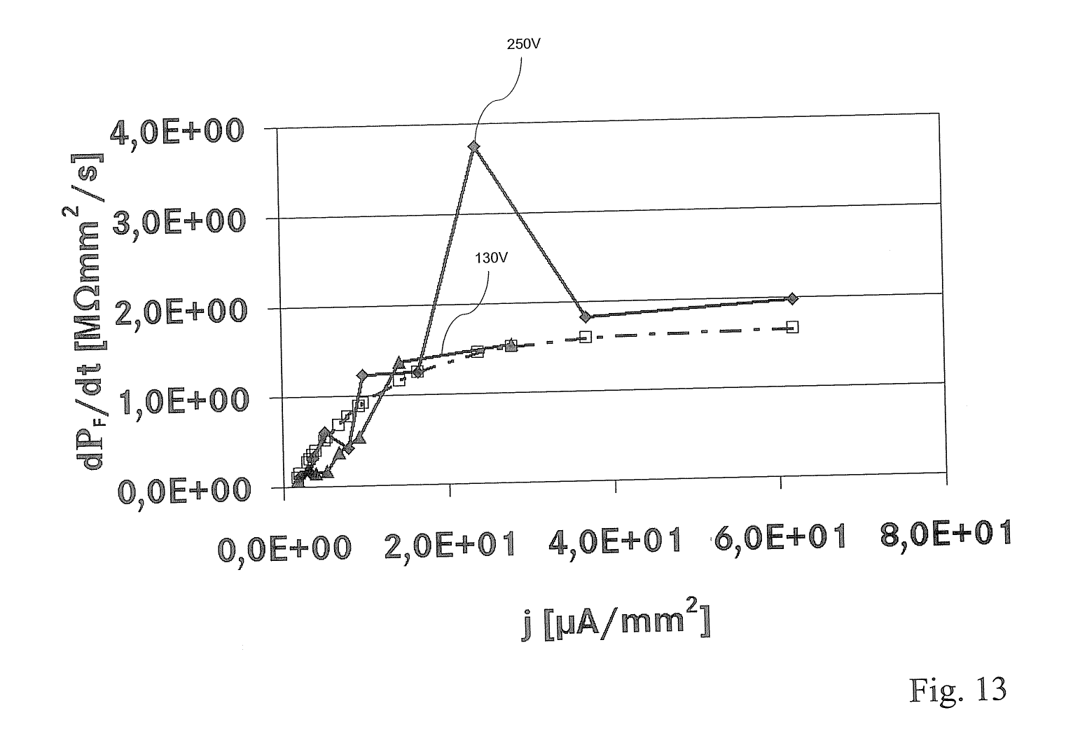

FIG. 13 shows the correlation betveen
the change over time of the layer resistance P_Paint=p_Paint*h, that is, the derivative over time of the d(p_Paint*h)/dt, and
the current density j through the paint layer 3.

On the y-axis the layer resistance P_Paint is indicated in [MΩ*mm²]. The growth first increases strongly and then approaches asymptotically a saturation level.

In FIG. 13 there is shown besides this, as a dashed line, the functional correlation determined by the regression analysis dP_Paint/dt-dP0_Paint*[l−e⁻y*^{(j-j0)}].

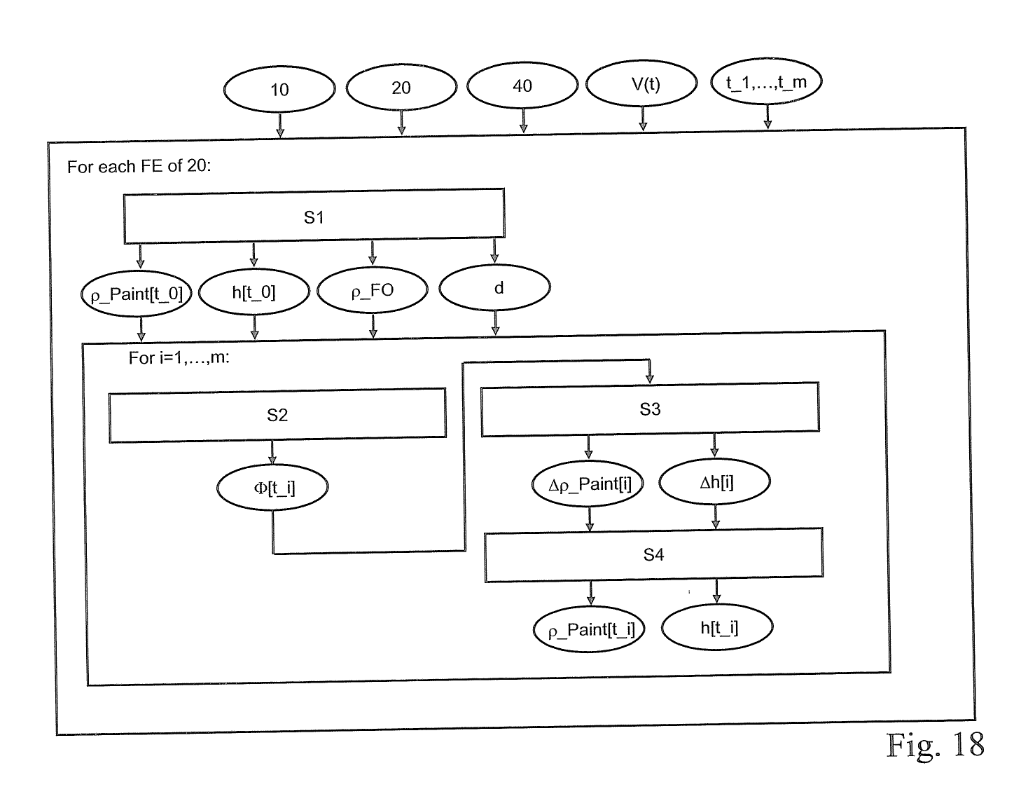

In the following it is described how the layer thickness is predicted for the work piece 2. FIG. 18 illustrates this calculation via a flow diagram.

A computer accessible three-dimensional construction model 20 of the unpainted work piece 2 is predefined for the process. This construction model 20 describes the geometry of at least those areas of the surface of the work piece 2 to be painted which come into contact with the liquid in the dip basin 1. It is unnecessary that the construction model 20 also describes the areas of the work piece 2 that do not come into contact with the liquid in the dip basin 1. The construction model 20 describes at the same time that the geometry of the cathode. Besides this it describes the wall thickness of the work piece 2.

This construction model 20 is integrated according to the method of the finite element. The method of the finite element is known for example from Dubbel, a.a.O, C 48 through C 50. A certain amount of points on the construction model 20 which are referred to as knot points, are determined. As finite elements those surfaces or volume elements are identified, of which the geometry are defined by knot points. The knot points form a lattice in the model for which reason the process of determining knot points and finite elements is referred to “latticing of the model”. The result of the process is referred to as finite element latticing.

Preferably essentially the surface of the work piece 2 is latticed or networked. The thereby produced surface elements, for example triangles and/or squares, approximately describe the surface.

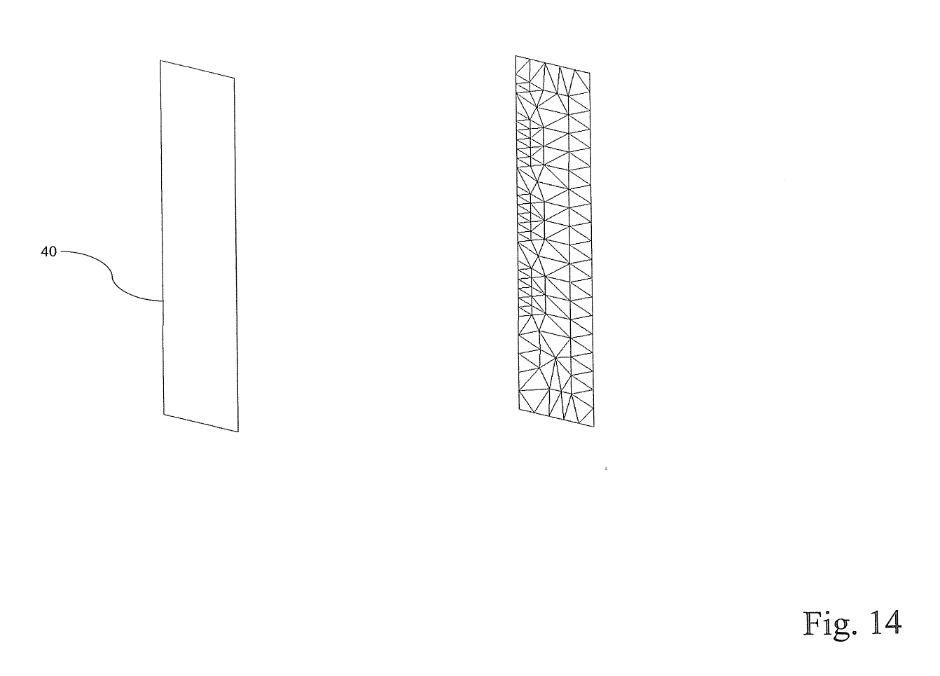

A computer accessible construction model 40 is also predefined for the illustrative embodiment which describes the geometry of the surface of the anode 4. Also this anode construction model 40 is networked. It thereby produced surface elements to describe approximately the surface of the anode 4. FIG. 14 shows a construction model 40 for an anode 4 (left) as well as a networking of this construction model 40 by means of surface elements (right).

Further, a computer accessible construction model 10 is predefined, which describes the geometry of the walls of the dip basin 1. A further predefined or specified computer accessible model 50 describes the surface of the holder or framework 5. On this holder 5 the work piece 2 is held during the dip painting and among other things is moved in the dip basin 1. Also the construction model 10 of the dip basin 1 is networked.

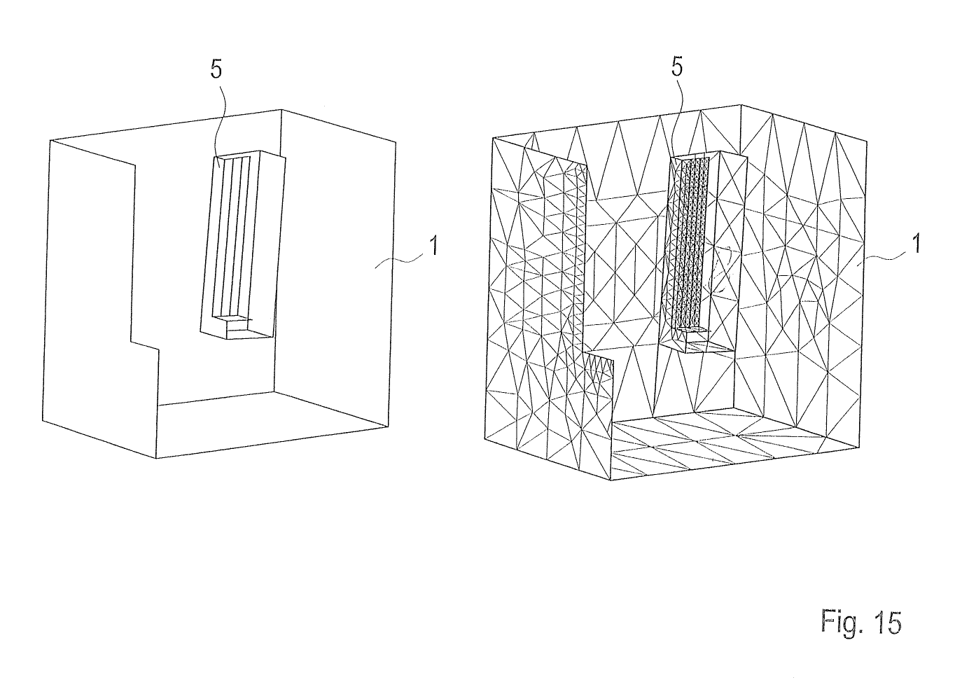

Further, both the dip basin 1 as well as the work piece 2 are symmetrical. In order to save computation time, this symmetry is utilized, in that the construction model 10 basically describes one-half of the dip basin 1. FIG. 15 shows left for example the left half of the dip basin 1 with two half side-walls, a half floor and a back wall. Further, holders or frameworks are shown. In FIG. 15 right a networking of the construction model 10 of this dip basin 1 is indicated. This networking is comprised of surface elements and describes approximately the walls and the floor of the dip basin 1 as well as the frame 5.

Further, the process is provided with a computer accessible description of the respective position of each anode 4 in the dip basin 1 relative to the work piece 2. Preferably, this occurs in that a computer accessible three dimensional coordinate system 11 is preset. The dip basin construction model 10, the work piece construction model 20, the frame construction model 50 and the anode construction model 40 are placed or oriented in this coordinate system 11.

It is possible that the work piece 2 is moved in the dip basin 1 during painting. In this case the position and/or orientation of the work piece construction model 20 is appropriately changed in the coordinate system 11.

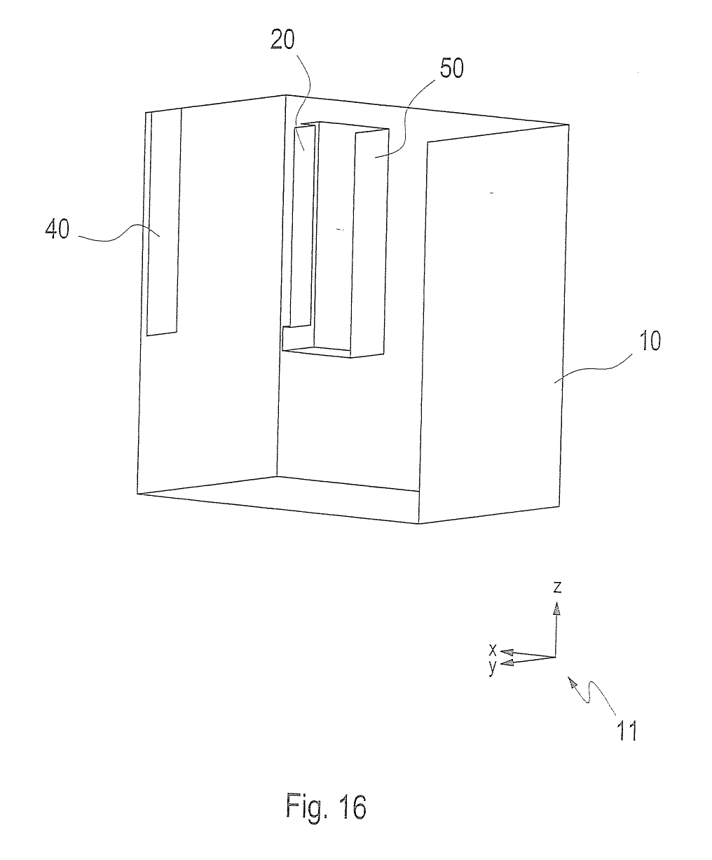

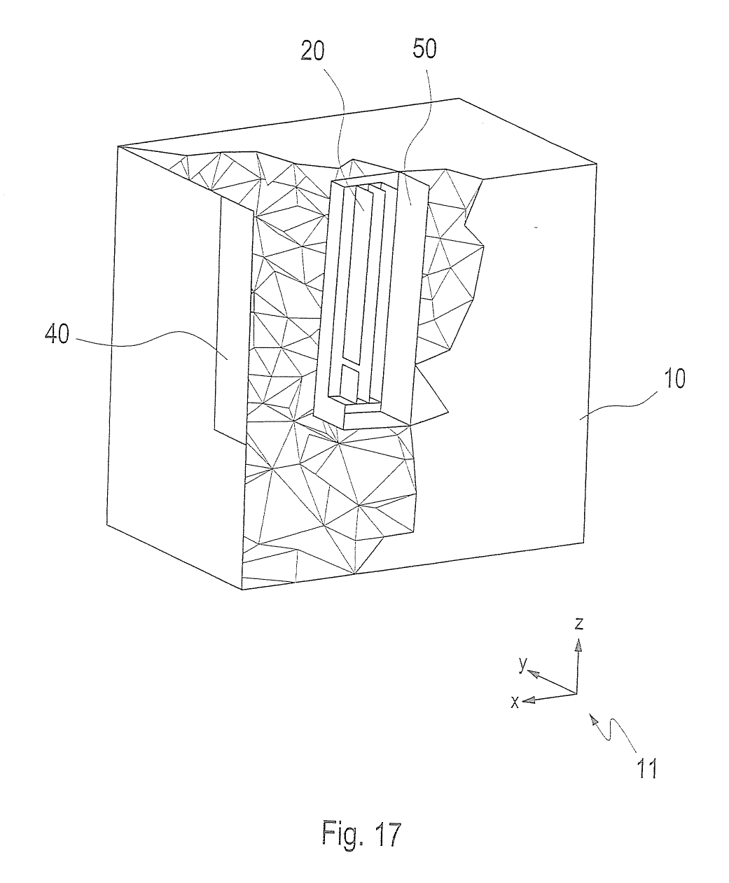

FIG. 16 shows for example the dip basin construction model 10, the holder construction model 50, and the anode construction model 40 in the coordinate system 11. FIG. 17 shows a networking of the inner surface of the dip basin of FIG. 16 with volume elements.

In the example of FIG. 16, the work piece 2 is comprised of multiple parallel sheets. FIG. 16 shows the dip basin construction model 10, the holder construction model 50, the anode construction model 40 and the work piece construction model 20 in the coordinate system 11. The inside of the dip basin 1 is described by volume elements which are indicated in FIG. 17.

Further predefined is the voltage (t), which is applied to the anode 4 and then occurs between the anode 4 and the cathode. This voltage (t) can be varied over time.

Assume T is the painting time. Predefined are m prediction points in time 0=t_{—}0<t_{—}1<t_{—}2< . . . , t_m=T. In Step 1 of the flow diagram of FIG. 18 an initialization is carried out. For this start values p_Paint [t_{—}0] and h [t_{—}0] are determined, for example both values could equal 0. Besides this values for p_FO and D are determined for example using the construction model 20.

During the carrying out of the process the electrical field E and therewith the voltage distribution in the electrolyte as well as on the work piece 2 to be coated are calculated. In the embodiment the electrical field E and the voltage distribution are calculated with approximation by a finite element simulation. From the electrical field E the locationally changing voltage gradient ∇Φ at the cathode is deduced. From this voltage gradient ∇Φ in turn the layer thickness, which results from the deposition of the material on the work piece 2, is calculated.

It is assumed that the current flows perpendicular through the sheet shaped work piece 2. Under this assumption, which is a generally satisfied condition, the following Laplace equation applies: E=−∇Φ

Herein E represents the electrical field and ∇Φ the voltage gradient.

The resistance R and therewith the layer resistance P is just so large, that it allows the voltage Φ on the surface of the work piece 2 to be coated allows it to fall to 0. From this boundary condition it follows:
−Φ(t)=j(t)*P(t), accordingly Φ (t)+j(t)*P(t)=0

Herein the Φ denotes the electrical potential on the surface of the work piece 2, j the current density and P the total above described layer resistance of the work piece 2. The surface changes during the painting process. All three values are changeable over time.

The not painted work piece 2 and the paint layer 3 of the paint applied in the electrolytic bath fonn a series connection. The total layer resistance P is comprised additively of the layer resistance P_FO of the not painted work piece 2 and the time changing layer resistance P_paint (t) of the paint layer 3 growing during painting. P_FO remains constant during the painting process. Thus, the following applies:
Φ(t)+j(t)*{P_{—}FO+P_Paint (t)}=0.

For the layer resistances P_FO and P_Paint (t) there applies: P_FO=p_FO*d and P_Paint (t)=p_Paint (t)*h(t). Herein p_FO is the—remaining constant over time during coating—specific resistance of the not painted work piece 2, p_Paint (t) the specific resistance of the paint layer 3, d the time constant roll thickness of the not painted work piece 2, and h(t) the layer thickness of the paint layer 3. Both the specific resistance p_Paint (t) as well as the thickness h(t) of the paint layer 3 are treated in the simulation as values changeable over time. This increases the approximation to reality to the simulation and therewith the accuracy of the prediction.

From this it follows:
Φ(t)+j(t)*{p_{—}FO*d+p_Paint (t)*h(t)}=0.

The work piece construction model 20 defines the wall thickness d of the work piece 2. The process is further simulated in a step S1 there is predefined the specific resistance p_FO of the not painted work piece 2, for example likewise as component of the work piece construction model 20. The specific resistance p_Paint (t) and the thickness h(t) of the paint layer 3 are further dynamically calculated by the process, since the thickness h(t) of the paint layer 3 does not build up until during the coating process.

As already mentioned above, m prediction time points 0=t_{—}0, t_{—}1<t_{—}2< . . . t_m =T. For approximating the current density j is assumed to be constant between two time points t_i−1 and t−i. This current density constant over time is calculated by j [t_i]. Then it applies, for i=1, . . . , m:
Φ[t_{—}i]+j [t_{—}i}*{p_{—}FO*d+p_Paint [t_{—}i]*h [t_{—i]}=}0.

Using the work piece construction model 20 the dip basin construction model 10 and the anode construction model 40 for each time point t-i (i=1, . . . , m) a finite element simulation is carried out. By the finite element simulation the Φ[t_i] is calculated.

Preferably for each surface element FE of the work piece construction model 20 and for each time point t_i a value for Φ[t_i] is calculated. This occurs in step S2 of the flow diagram of FIG. 18. Also taken into consideration is that the electrical potential on the surface of the work piece 2 is variable both locationally as well as over time. In order to compute the Φ[t_i], then neither the layer thickness h nor the specific resistance p_Paint of the paint layer are necessary.

In the equation
Φ[t_{—}i]+j [t_{—}i*{p_{—}FO*d+p_Paint [t_{—}i]*h[t_{—}i]}=0
The current density j [t_i] occurs on the one hand directly at time t_i. On the other hand the layer resistance p_Paint [t_i] and the layer thickness h [t_i] depend upon the current density j [t_i].

The layer thickness h and the layer resistance p_Paint are calculated stepwise for the time points t_i, t_{—}2, . . . and namely beginning with i=1. In step S1 h[t_{—}0] and p_Paint [t_{—}0] are provided or simulated. Preferably it is valid that h [t_{—}0]=p_Paint [t_{—}0]=0. Further it is valid for i=1, . . . , m
h[t_{—}i]=h[t_{—}i−1]+Δh[i] and
p_Paint [t_{—}i]=p_Lack[t_{—}i−1]+Δp_Paint[i].
Herein the layer growth in the time from t_i−1 through t_i is characterized by Δh[i], the growth of the layer resistance in the time from t_i−1 with Δp_Paint[i].

From this it follows:
Φ[t_{—}i]+j[t_{—}i]*{p_{—}FO*d+(p_Paint[t_{—}i−1]+Δp_Paint[i])*(h[t_{—}i−1]+Δh[i])}=0

On the basis of the stepwise calculation this equation has the unknown j[t_i], Δp_Paint[i] and Δh[i]. In step S3 in FIG. 18 j[t_i], Δp_Paint[i] and Δh[i] are calculated. The variables h[t_i−1] und p_Paint [t_i−1] are calculated in the preceding calculating step and are now known. In step S4 p_Paint [t_i] and h [t-i] are calculated by simulation.

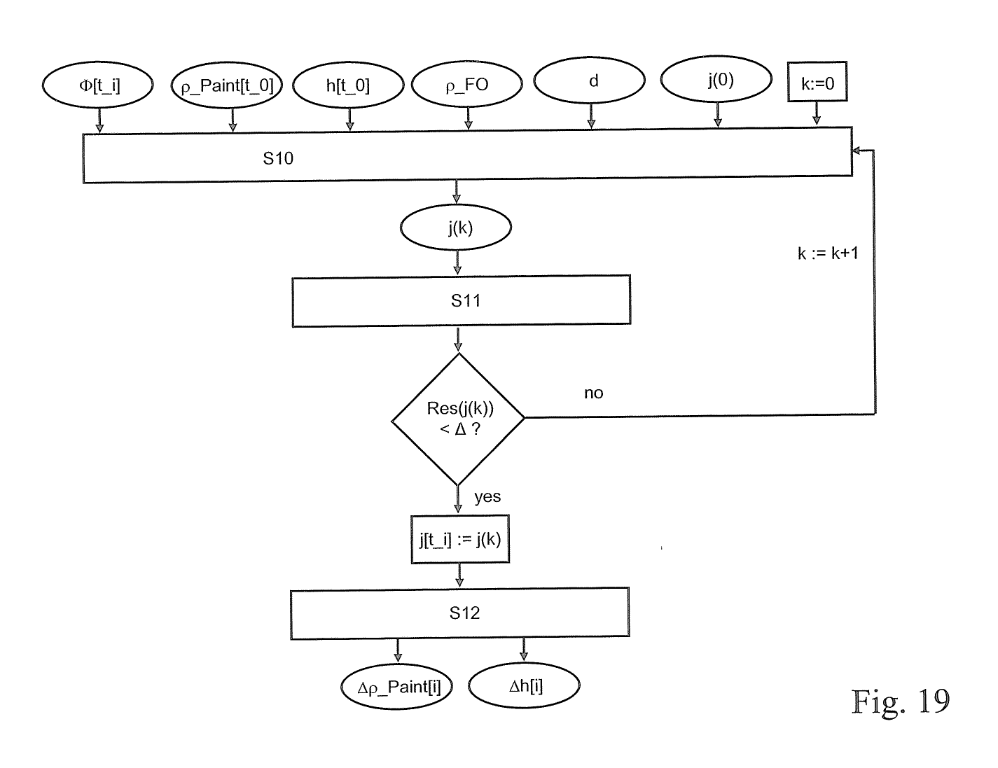

In the following it is described how j [t_i], Δh[i] and Δp_Paint [i] are calculated in step S3 for a time point t_i. This computation is illustrated in detail in FIG. 19.

The two physical values Δh[i] and Δp_Paint [i] are treated as functions of j. The growth

$$\frac{ⅆ h}{ⅆ t}$$

over the layer thickness h as well as the growth

$$\frac{ⅆ ρ}{ⅆ t}$$

of the specific layer resistance p in time from t_i−1 and t_i are likewise approximately constant over time.

Above it was described how the following correlations were determined empirically

$$\frac{ⅆ h}{ⅆ t} = AE * {( j - J 0 )}^{α} and \frac{ⅆ ρ\_Paint}{ⅆ t} = d ρ 0 \_Paint * [ 1 - {ⅇ}^{- β * ( j - j 0 )} ]$$

As already described above, m prediction time points 0=t_{—}0<t_{—}1<t_{—}2< . . . <t_m=T are simulated. Δt_i is the time separation between t_i and t_i−1. Under the assumption that the current density between two time points t_i−1 and t-i are constant with the value j[t_i] it follows:

$$\begin{matrix}\frac{Δ h [ i ]}{Δ t\_i} = AE * {( j [ t\_i ] - j 0 )}^{α} and \frac{ Δ ρ\_Paint [ i ]}{Δ t\_i} \\ = d ρ 0 \_Paint * [ 1 - {ⅇ}^{- β * ( j [ t\_i ] - j 0 )} ]\end{matrix}$$

This is plugged into the above equation, in order to remove all unknowns up to j[t_i]. From this it follows:
Φ[t_{—}i]+j[t_{—}i]*{p_{—}FO*d+(p_Paint[t_{—}i−1]+Δp_Paint[i])*(h[t_{—}i−1]+Δh[i])}
Φ[t_{—}i]+j[t_{—}i]*{p_{—}FO*d+(p_Paint[t_{—}i−1]+dp0Paint*[1−e^{-β*(j[t}^{_{—i]−j0)}}]*Δt₁₃ i)* (h[t_{—}i−1]+AE*(j[t_{—}i]−j0)^{α}*Δt_{—}i) =0.

In this equation the unknown appears only as j [t_i]. Preferably a numeric process is employed for computation of a zero point of a function. This function is the residual Res [t_i] depending only upon j, with
Res[t_{—}i](j):=Φ[t_{—}i]+j*{p_{—}FO*d+(p_Paint[t_{—}i−1]+dp0_Paint*[1−e^{-β*(j-j0)}]*Δt_{—}i)* (h[t_{—}i−1]+AE*(j−j0)^{α}*Δt_{—}i).

The numeric calculated zero point of Res[t_i] is used as value for j[t_i].

In an illustrative embodiment this minimization is carried out iteratively. For each point of time t_n a series j(1), j(2), j(3), . . . is calculated. The respective residual Res[t_i] Res[t_i](j(1)), Res[t_i](j(2)), Res[t_i](j(3)), . . . are likewise calculated.

The iteration is interrupted as soon as the interruption or end criteria is satisfied. The interruption or end criteria is satisfied for example when|Res[t_n](j(k))|<Δ applies, where Δ is a predeterrnined boundary.

Preferably a new value for j is calculated according to the computational step

$$j ( k + 1 ) = j ( k ) - \frac{Res [ t\_n ] ( j ( k ) )}{\frac{ⅆ}{ⅆ ( j )} Res [ t\_n ] ( j ( k ) )}$$

Instead step S4 of FIG. 18 is calculated:
h[t_{—}i]=h[t_{—}i−1]+Δh[i] and
p_Paint[t_{—}i]=p_Paint[t_{—}i−1]+Δp_Paint[i].

### List of the Used Reference Numbers and Symbols

| Symbol | Meaning |
|---|---|
| 1 | Dip bath for electrolytic painting |
| 2 | Work piece with electrically conductive surface |
| | to be painted |
| 3 | Paint layer applied upon the work piece 2 |
| 4 | Anode in dip basin 1 |
| 5 | Holder in dip basin 1 for the work piece 2 |
| 10 | Computer accessible three-dimensional |
| | construction model of the dip basin 1 |
| 11 | Computer accessible three-dimensional |
| | coordinate system |
| 20 | Computer accessible three-dimensional |
| | construction model of the work piece 2 |
| 31 | Electrically conductive paint |
| 32 | Phosphatizing |
| 33 | Organic layer |
| 34 | Zinc particle |
| 40 | Computer accessible three-dimensional |
| | consutruction model for anode 4 |
| 50 | Computer accessible three-dimensional |
| | construction mode of holder 5 |
| 101 | Test dip basin for test painting of the work |
| | piece 102 |
| 102 | Test work piece comprised of three sheets |
| 103 | Switch |
| d | Wall thickness of the unpainted work piece 2 |
| E | Electrical field in the painted work piece 2 |
| h(t) | Paint layer 3 varying in thickness over time |
| Δh[i] | Growth of the paint layer 3 in time span of |
| | t_i − 1 through t_i |
| j | Current density of the painted work piece 2 |
| m | Number of the prediction time points |
| P | Time variable layer resistance of the painted |
| | work piece 2 |
| P_FO | Time constant layer resistance of the work |
| | piece 2 without paint layer 3 |
| P_Paint(t) | Time changeable layer resistance of the paint |
| | layer 3 |
| Res[t_i] | Residual for computation of j[t_i] |
| ρ | Specific resistance of the painted work piece 2 |
| ρ_FO | Time constant specific resistance of the work |
| | piece 2 without paint layer 3 |
| ρ_Paint(t) | Time changing specific resistance of the paint |
| | layer 3 |
| Δρ_Paint[i] | Growth of the resistance in time span of |
| | t_i − 1 |
| ∇Φ | Voltage gradiant |
| Φ | Electrical potential on the surface of the work |
| | piece 2 |
| t_1, . . . , t_m | Prediction time points |
| Δt_i | Time separation between t_i und t_i − 1 |
| V(t) | Voltage between anode 4 and cathode in dip |
| | basin 1 |

1. A process for the prediction of the thickness (h) of a paint layer (3) at at least one point of the surface of an object (2), wherein the paint layer (3) is applied upon the object (2) by a dip painting, wherein the dip painting includes the steps:
dipping the object (2) into a dip basin (1), which contains a liquid paint,
producing an electrical field in the dip basin (1) by application of a voltage (U), wherein the object (2) functions as electrode and a counter-electrode (4) is present, which process includes the steps automatically carried out using a data processing unit:
calculating the electrical potential (Φ) at the point depending upon the magnitude of the applied voltage (U),
depending upon the calculated potential (Φ), calculating the current density (j) at the point, and
depending upon the calculated current density (3), predicting the layer thickness (h) at the point,
and including
emperically determining a coorelation between the paint layer thickness (h) and the current density (j) in the paint layer (3), and
emperically determining a correlation between the specific resistance (p_Paint) of the paint layer (3) and the current density (j) in the paint layer (3),
wherein the paint layer thickness (h) and the specific resistance (p_Paint) of the paint layer (3) is calculated at the point after the dip painting using
the electrical potentional (Φ) at the point and
the two empirically determined correlations.

2. The process according to claim 1, wherein a correlation between the thickness growth
$$( \frac{ⅆ h}{ⅆ t} )$$
and the current density (j) is determined and used as the correlation between paint layer thickness and current density (j), and a correlation between the growth
$$( \frac{ⅆ ρ}{ⅆ t} )$$
of the
specific resistance (p_Paint) of the paint layer (3) is determined and used as the correlation between specific resistance (p_Paint) and current density (j).

3. The process according to claim 2, wherein multiple prediction time points (t_{—}1 , . . . , t_m) lying in the time of the dip painting are predetermined and the respective thickness (h) of the paint layer (3) at the point for each prediction time point (t_{—}1, . . . , t_m) is calculated, wherein for each prediction time point (t_{—}1, . . . , t_m)
with use of the two empirically determined correlations the thickness growth
$$( \frac{ⅆ h}{ⅆ t} )$$
of the paint layer (3) and the increase of the specific resistance that
$$( \frac{ⅆ ρ\_Pa int}{ⅆ t} )$$
of the paint layer (3) in the time between the precding prediction time point and the prediction time point is calculated,
the paint layer thickness (h) at the prediction time point is calculated as the sum of the paint layer thickness (h [t_i]) at the preceding prediction time point and thickness growth(Δh[i]) and
the specific resistance of the paint layer (3) at the prediction time point is calculated as the sum of the specific resistance (p_Paint [t_i−1]) of the paint layer (3) at the preceding time point and growth(Δp_Paint[i]) of the specific resistance (p_Paint).

4. The process according to claim 1, wherein the respective paint layer thickiness (h) is computed at a first point and a second point of the surface of the object (2) wherein for each computation the same empirically determined correlations are employed.

5. The process according to claim 1, wherein the thickness (d) and the specific resistance (p_FO), which the object (2) exhibits prior to dip painting at the point, are predetermined and additionally are employed for the computation for the paint layer thickness (h).

6. The process according to claim 1, wherein
the process steps are formulated as program code, and
the program code is a component of a computer program, which runs on a data processing unit

7. A computer program-product, which can be loaded to a memory of a computer and includes software steps, which can be carried out by a process according to one of claim 1, when the product is running on a computer.

8. A computer program-product, which is stored on a computer readable medium and including includes a computer readable program means, which allows the computer to carry out a process according to one of claim 1.

9. A digital storage medium with electronic readable control signals adapted to interface with a programmable data processing unit, such that a process according to one of claim 1 can be carried out.

10. A device for predicting the thickness (h) of a paint layer (3) at at least one point of the surface of an object (2),
wherein the paint layer (3) is applied upon the object (2) by a dip painting, wherein the dip painting includes the steps:
dipping the object (2) into a dip basin (1), which contains a liquid paint,
producing an electrical field in the dip basin (1) by application of a voltage (U),
wherein the object (2) functions as electrode and a counter-electrode (4) is present,
wherein the device includes a data processing unit adapted for predicting the thickness (h) of a paint layer (3) at at least one point of the surface of an object (2) and for automatically carrying out the following steps:
calculating the electrical potential (Φ) at the point depending upon the magnitude of the applied voltage (U),
depending upon the calculated potential (Φ), calculating the current density (j) at the point, and
depending upon the calculated current density (j), predicting the layer thickness (h) at the point,
and including
emperically determining a coorelation between the paint layer thickness (h) and the current density (j) in the paint layer (3), and
emperically determining a correlation between the specific resistance (p_Paint) of the paint layer (3) and the current density (j) in the paint layer (3),
wherein the paint layer thickness (h) and the specific resistance (p_Paint) of the paint layer (3) is calculated at the point after the dip painting using
the electrical potentional (Φ) at the point and
the two empirically determined correlations.
